(19) United States
(12) Patent Application Publication
(10) Pub. No.: US 2026/0287520 A1
(43) Pub. Date: Sep. 24, 2026

(54) WAFER INSPECTION SYSTEM AND METHOD THEREOF

(71) Applicants: TSMC CHINA COMPANY LIMITED, Shanghai (CN); TAIWAN SEMICONDUCTOR MANUFACTURING COMPANY, LTD., Hsinchu (TW)

(72) Inventors: Peng ZHANG, Shanghai City (CN); Da-Fei PEI, Shanghai City (CN); Yun-Cheng WANG, Shanghai City (CN); Fred PI, Shanghai City (CN); Dean CHEN, Shanghai City (CN); Colin WANG, Shanghai City (CN)

(73) Assignees: TSMC CHINA COMPANY LIMITED, Shanghai (CN); TAIWAN SEMICONDUCTOR MANUFACTURING COMPANY, LTD., Hsinchu (TW)

(21) Appl. No.: 19/173,296

(22) Filed: Apr. 8, 2025

(30) Foreign Application Priority Data
Mar. 21, 2025 (CN) 202520514638.0

(51) Int. Cl. G01N 21/95

(52) U.S. Cl. CPC G01N 21/9501; G01N 2201/06113; G01N 2201/0636; G01N 2201/105

(57) ABSTRACT

A method includes performing a first wafer inspection process using an illumination source in a wafer inspection tool; replacing the illumination source with a new illumination source; generating a radiation beam from the new illumination source; placing an assisting tool along a propagation path of the radiation beam, wherein the assisting tool has a hole, and wherein the radiation beam creates a light spot around the hole of the assisting tool; determining whether the propagation path of the radiation beam is along a predetermined propagation path based on a position of the hole and a position of the light spot; and performing a second wafer inspection process using the new illumination source in response to the propagation path of the radiation beam being determined as along the predetermined propagation path.

### PRIORITY CLAIM AND CROSS-REFERENCE

The present application claims priority to China Application Serial Number 202520514638.0, filed Mar. 21, 2025, which is herein incorporated by reference.

### BACKGROUND

Fabricating semiconductor devices, such as logic and memory devices, typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation.

Inspection processes are used at various steps during a semiconductor manufacturing process to detect defects on wafers or reticles to promote higher yield in the manufacturing process and thus higher profits. However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary since even relatively small defects may cause unwanted aberrations in the semiconductor devices. Furthermore, as design rules shrink, semiconductor manufacturing processes may be operating closer to the limitations on the performance capability of the processes, and smaller defects can have an impact on the electrical parameters of the device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a wafer inspection optical system in accordance with some embodiments of the present disclosure.

FIG. 2 is a schematic view of a wafer inspection system in accordance with some embodiments of the present disclosure.

FIGS. 3A to 3D are schematic views of an assisting tool in accordance with some embodiments of the present disclosure.

FIGS. 4A to 4B illustrate the relationship between an assisting tool and a fixing lug in accordance with some embodiments of the present disclosure.

FIGS. 5A to 5B illustrate different conditions of determining a propagation path of a radiation beam in accordance with some embodiments of the present disclosure.

FIGS. 6A to 6D are schematic views of an assisting tool in accordance with some embodiments of the present disclosure.

FIGS. 7A to 7B illustrate the relationship between an assisting tool and a fixing lug in accordance with some embodiments of the present disclosure.

FIGS. 8A to 8B illustrate different conditions of determining a propagation path of a radiation beam in accordance with some embodiments of the present disclosure.

FIG. 9 is a method of replacing an illumination source of a wafer inspection system in accordance with some embodiments.

FIGS. 10A and 10B illustrate the relationship between an assisting tool and a fixing lug in accordance with some embodiments of the present disclosure.

FIG. 11 is block diagram of a wafer inspection system in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

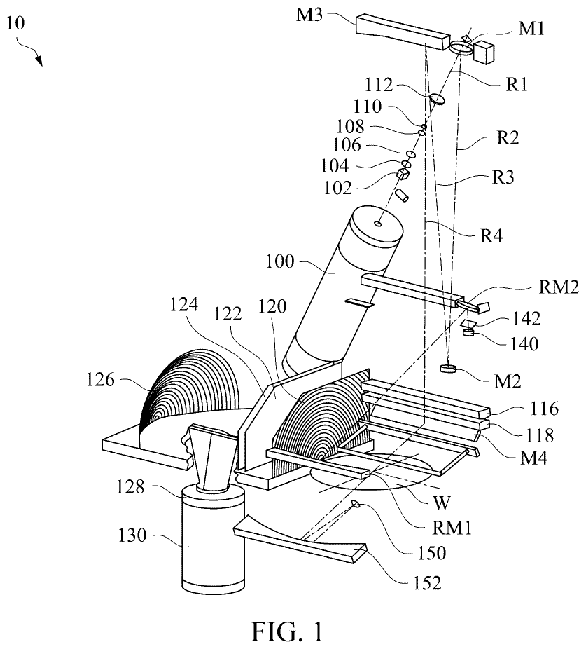

FIG. 1 is a schematic view of a wafer inspection optical system in accordance with some embodiments of the present disclosure. Shown there is a wafer inspection optical system 10. In some embodiments, the wafer inspection optical system 10 is configured to detect and categorize defects on a semiconductor wafer, enabling manufacturers to identify and rectify potential issues early in the production process. In some embodiments, the wafer inspection optical system 10 may be able to capture high-resolution images of a wafer surface to detect defects on the wafer surface. In some embodiments, the wafer inspection optical system 10 may also be able to automatically classify the types of defects based on their size, shape, and location. The wafer inspection optical system 10 is configured to generate an early defect detection, which leads to higher yield rates and improved overall quality control. Moreover, the wafer inspection optical system 10 provides real-time monitoring of wafer quality, which minimizes the risk of yield losses caused by process deviations. Last but not the least, catching defects early can also reduce production costs and improve profitability. In some embodiments, the wafer inspection optical system 10 can be used in memory device manufacturing, logic device manufacturing, and advanced packaging within the semiconductor industry. It is understood that the optical elements illustrated in FIG. 1 are merely used to explain, the disclosure is not limited thereto. Some optical elements can be omitted, and the wafer inspection optical system 10 may also include other optical elements that are not present in FIG. 1.

The wafer inspection optical system 10 includes an illumination source 100. In some embodiments, the illumination source 100 may generate a radiation beam R1 toward a turning mirror M1. In the present embodiments, the illumination source 100 may be a 30 MW argon (Ar) laser source, while the disclosure is not limited thereto. In other embodiments, the illumination source 100 may also include, by way of example, a laser, a diode laser, a helium neon laser, a solid state laser, a diode pumped solid state (DPSS) laser, a xenon arc lamp, a gas discharging lamp, and LED array, an incandescent lamp, or other suitable laser source.

Along the propagation path of the radiation beam R1 between the illumination source 100 and the turning mirror M1, the radiation beam R1 may pass several optical elements, such as a polarizing cube 102, a half wave plate 104, a quarter wave plate 106, a first lens 108, a spatial filter 110, and a second lens 112.

In some embodiments, the polarizing cube 102 may be a polarizing beam splitter cube, a Wollaston prism or some another suitable polarizing beam splitter. For example, the polarizing cube 102 may be constructed of two cemented right angle prisms. In some embodiments, the polarizing cube 102 is configured to allow portion of radiation with proper polarization to pass through.

The radiation passing through the polarizing cube 102 propagates to the half wave plate 104. In some embodiments, the half wave plate 104 allows the polarization to be dynamically rotated between P polarized (parallel to the plane of incidence), S polarized (perpendicular to the plane of incidence) and 45° polarized (between P and S) light.

The radiation passing through the half wave plate 104 propagates to the quarter wave plate 106. In contrast to half wave plate 104, the quarter wave plate 106 produce a phase delay of quarter wavelength. If the quarter wave plate 106 is oriented 45° to a linearly polarized light beam, the output light beam would be circularly polarized and vice versa. In some embodiments, the half wave plate 104 and the quarter wave plate 106 may be collectively referred to as a beam shaping optics. The beam shaping optics (e.g., the half wave plate 104 and the quarter wave plate 106) may be configured to reshape the incoming beam to a circular shape cross-section.

The radiation passing through the quarter wave plate 106 propagates to the first lens 108. In some embodiments, the first lens 108 may be a focusing lens which is used to direct the radiation on to the spatial filter 110. In some embodiments, the first lens 108 may be a spherical lens.

The radiation passing through the first lens 108 propagates to the spatial filter 110. In some embodiments, the spatial filter 110 is used to remove the unwanted multiple-order energy peaks and pass only the central maximum of the diffraction pattern of the radiation. In addition, when a radiation passes through an optical path, dust in the air or on optical components can disrupt the beam and create scattered light. This scattered light can leave unwanted ring patterns in the beam profile. The spatial filter 110 may also removes this additional spatial noise from the system.

The radiation passing through the spatial filter 110 propagates to the second lens 112. In some embodiments, the second lens 112 may be a focusing lens which is used to direct the radiation on to the turning mirror M1. In some embodiments, the second lens 112 may be a spherical lens.

The turning mirror M1 may reflect the radiation beam R1, and redirect the radiation beam R1 toward a scanner mirror M2. In some embodiments, the radiation beam R1 reflected by the turning mirror M1 is referred to as a radiation beam R2. In some embodiments, the scanner mirror M2 may also be referred to as a scanner. The mirror in the scanner (e.g., the scanner mirror M2) can oscillate the angle with respect to the radiation beam passing through the scanner.

The scanner mirror M2 may reflect the radiation beam R2, and redirect the radiation beam R2 toward a telecentric scan mirror M3. In some embodiments, the radiation beam R2 reflected by the telecentric scan mirror M3 is referred to as a radiation beam R3.

The telecentric scan mirror M3 may reflect the radiation beam R3, and redirect the radiation beam R3 toward an incident mirror M4. In some embodiments, the radiation beam R3 reflected by the telecentric scan mirror M3 is referred to as a radiation beam R4. Along the propagation path of the radiation beam R4 between the telecentric scan mirror M3 and the incident mirror M4, the radiation beam R4 may pass a first cylindrical lens 114, a second cylindrical lens 116, and a third cylindrical lens 118. In some embodiments, the cylindrical lens is a lens which focuses light into a line instead of a point as a spherical lens would. The curved face or faces of a cylindrical lens are sections of a cylinder, and focus the image passing through it into a line parallel to intersection of the surface of the lens and a plane tangent to it along the cylinder's axis.

The incident mirror M4 may reflect the radiation beam R4, and redirect the radiation beam R4 onto a surface of a wafer W. When the radiation beam R4 illuminates a defect on the surface of a wafer W, the radiation light is scattered away from the point of incidence. In some embodiments, the scattered light may pass a Fresnel lens 120, a P-polarizer 122, an S-polarizer 124, a paraboloid collector 126, a collector attenuator 128, and a photomultiplier tube (PMT) 130.

In some embodiments, the Fresnel lens 120 is configured to focus the scattered light from the wafer W. The P-polarizer 122 and the S-polarizer 124 are configured to generate desired polarization state of the scattered light. The paraboloid collector 126 is configured to direct the scattered light to the photomultiplier tube (PMT) 130. The collector attenuator 128 is configured to control the power of the radiation into the photomultiplier tube (PMT) 130. In some embodiments, the photomultiplier tube 130 is configured to amplify the optical signal and generates a corresponding electrical output. The output of the photomultiplier tube 130 is digitized by an analog-to-digital converter (not shown). Then the particle position (e.g., defect position) on the wafer W can be determined based upon the collected radiation.

On the other hand, aside from the scattered light from the wafer surface, the radiation beam R4 may also be reflected by the wafer W. The reflected light may be directed to a reflectivity mirror RM1, the reflectivity mirror RM1 direct the light to a reflectivity mirror RM2, and the reflectivity mirror RM2 direct the light to a reflectivity detector 140 through a reflectivity attenuator 142. In some embodiments, the reflectivity attenuator 142 is configured to control the power of the radiation into the reflectivity detector 140. In some embodiments, the reflectivity detector is configured to amplify the optical signal and generates a corresponding electrical output. The output of the reflectivity detector 140 is digitized by an analog-to-digital converter (not shown). Then, the reflected light from the wafer W can be determined based upon the collected radiation.

On the other hand, the wafer inspection optical system 10 further includes a below wafer detector 150. When the wafer W is absent, the radiation beam R4 may be directed to the below wafer detector 150 through a below wafer parabolic mirror 152. In some embodiments, the below wafer detector 150 may be configured to detect the radiation intensity of the radiation beam R4.

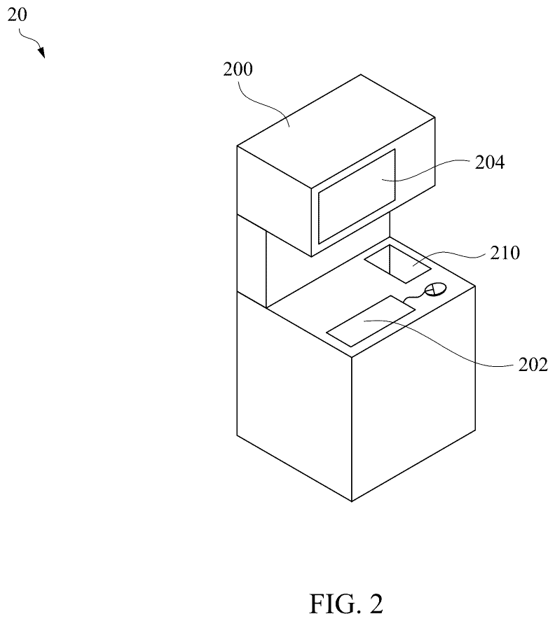

FIG. 2 is a schematic view of a wafer inspection system in accordance with some embodiments of the present disclosure. Shown there is a wafer inspection system 20. In some embodiments, the wafer inspection system 20 includes a wafer inspection tool 200. In some embodiments, the wafer inspection optical system 10 as discussed in FIG. 1 is integrated in the wafer inspection tool 200 of FIG. 2. The wafer inspection tool 200 includes a wafer load port 210. For example, a wafer (e.g., the wafer W as shown in FIG. 1) is placed in the wafer load port 210, and the wafer W will be transferred to an inspection position of the wafer inspection optical system 10 as discussed in FIG. 1.

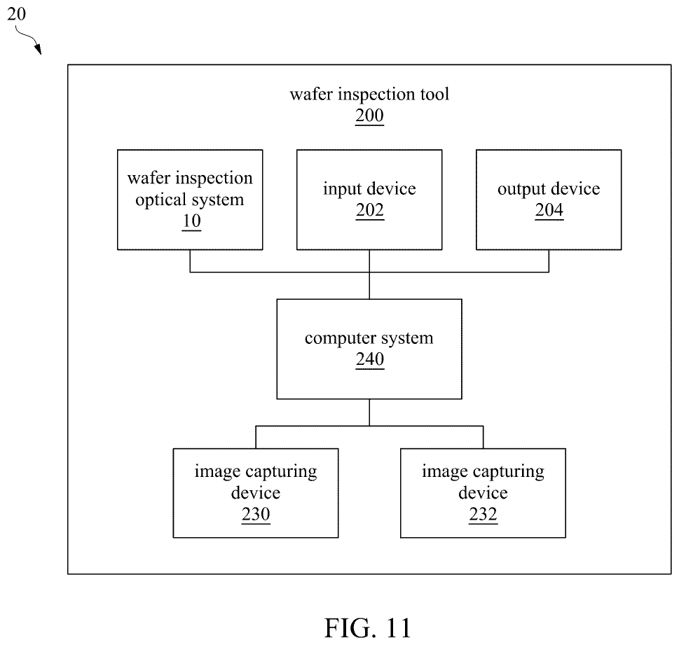

In some embodiments, the wafer inspection tool 200 also includes an input device 202 and an output device 204. The input device 202 is used to generate a wafer detecting instruction to a computer system (e.g., the computer system 240 in FIG. 11) integrated in the wafer inspection tool 200. The computer system may transmit an instruction signal to the wafer inspection optical system 10 (see FIG. 1) integrated in the wafer inspection tool 200. The inspection result of the wafer inspection optical system 10 will be sent back to the computer system, and the inspection result can be shown on the output device 204. In some embodiments, the input device 202 may include a keyboard, a mouse, or other suitable input devices. In some embodiments, the output device 204 may include a monitor, or other suitable output devices.

During the operation of the wafer inspection system 20, it is observed that the average lifetime of the illumination source (e.g., the illumination source 100 in FIG. 1) is about 10 month to about 12 month, and the used illumination source will be replaced with a new illumination source. For example, illumination source (e.g., the illumination source 100 in FIG. 1) is removed from the wafer inspection tool 200 of the wafer inspection system 20, and a new illumination source is installed into the wafer inspection tool 200 of the wafer inspection system 20. However, once the new illumination source is installed, the radiation beam may not propagate along a predetermined propagation path. That is, the propagation path of the radiation beam (e.g., the radiation beams R1, R2, R3, and/or R4 of FIG. 1) may offset from a predetermined propagation path, and such offset propagation path may adversely affect the inspection accuracy.

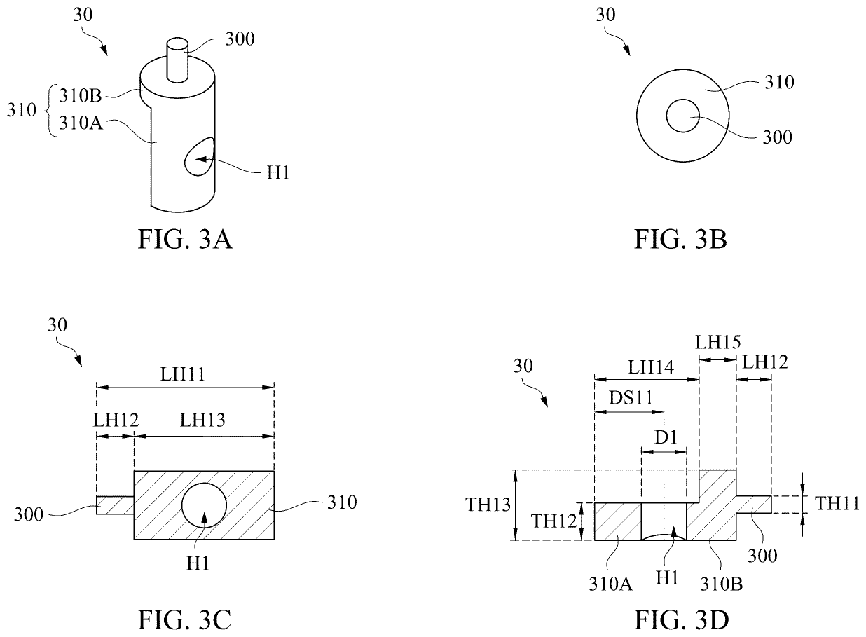

FIGS. 3A to 3D are various views of an assisting tool in accordance with some embodiments of the present disclosure. In greater detail, FIG. 3A is a schematic view of an assisting tool 30, FIG. 3B is a top view of the assisting tool 30, FIG. 3C is a side view of the assisting tool 30, and FIG. 3D is a cross-sectional view of the assisting tool 30. In some embodiments, the assisting tool 30 is used to check a propagation path of a radiation beam, and thus the assisting tool 30 can also be referred to as a beam checking tool.

The assisting tool 30 includes a fixing portion 300 and a body portion 310 connecting with each other. In greater detail, the body portion 310 further includes a first segment 310A and a second segment 310B connecting with each other. In some embodiments, the fixing portion 300 is in contact with the second segment 310B of the body portion 310. That is, the second segment 310B of the body portion 310 is between the fixing portion 300 and the first segment 310A of the body portion 310.

In some embodiments, the fixing portion 300 and the second segment 310B of the body portion 310 both include a cylindrical shape, while the first segment 310A of the body portion 310 includes a half-cylindrical shape. That is, the fixing portion 300 and the second segment 310B of the body portion 310 both include a circular cross-sectional profile, while the first segment 310A of the body portion 310 includes a substantially semicircular cross-sectional profile, while the disclosure is not limited thereto. In some embodiments, the first segment 310A of the body portion 310 includes a curved surface connecting with a flat surface. In some embodiments, the diameter of the circular cross-sectional profile of the fixing portion 300 is smaller than the diameter of the circular cross-sectional profile of the second segment 310B of the body portion 310.

In some embodiments, the body portion 310 may include a hole H1 penetrating through the first segment 310A of the body portion 310. Specifically, the hole H1 may extend from the flat surface of the first segment 310A of the body portion 310 to the curved surface of the first segment 310A of the body portion 310. Stated another way, a first end of the hole H1 may be at the flat surface of the first segment 310A of the body portion 310, and a second end of the hole H1 may be at the curved surface of the first segment 310A of the body portion 310. In some embodiments, the hole H1 may include a circular profile.

As shown in FIG. 3C, along a longitudinal direction of the assisting tool 30, the assisting tool 30 includes a length LH11, the fixing portion 300 of the assisting tool 30 includes a length LH12, and the body portion of the assisting tool 30 includes a length LH13, in which the length LH11 is the sum of the length LH12 and the length LH13. In some embodiments, the length LH11 is about 47.5 mm to about 48.5 mm, such as 48 mm. The length LH12 is about 9.0 mm to about 10.0 mm, such as 9.5 mm. The length LH13 is about 38.0 mm to about 39.0 mm, such as 38.5 mm.

As shown in FIG. 3D, the first segment 310A of the body portion 310 of the assisting tool 30 includes a length LH14 and the second segment 310B of the body portion 310 of the assisting tool 30 includes a length LH15, in which the length LH13 is the sum of the length LH14 and the length LH15. In some embodiments, the length LH14 is about 28.0 mm to about 29.0 mm, such as 28.5 mm. In some embodiments, the length LH15 is about 9.5 mm to about 10.5 mm, such as 10 mm. The hole H1 include a diameter D1. In some embodiments, the diameter D1 is about 11.5 mm to about 12.5 mm, such as 12 mm. The center of the hole H1 and an outer sidewall of the first segment 310A of the body portion 310 of the assisting tool 30 has a distance DS11 therebetween. In some embodiments, the distance DS11 is about 18.5 mm to about 19.5 mm, such as 19 mm. The fixing portion 300 of the assisting tool 30 includes a thickness TH11 (or diameter). In some embodiments, the thickness TH11 is about 4.2 mm to about 5.2 mm, such as 4.7 mm. The first segment 310A of the body portion 310 of the assisting tool 30 includes a thickness TH12, and the second segment 310B of the body portion 310 of the assisting tool 30 includes a thickness TH13 (or diameter). In some embodiments, the thickness TH12 is about 7.6 mm to about 8.6 mm, such as 8.1 mm. In some embodiments, the thickness TH13 is about 15.3 mm to about 16.3 mm, such as 15.8 mm.

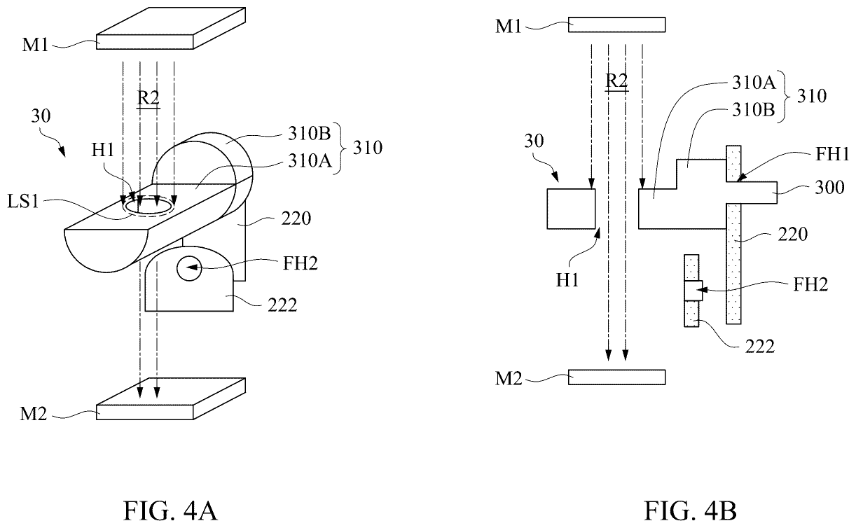

FIGS. 4A to 4B illustrate the relationship between an assisting tool and a fixing lug in accordance with some embodiments of the present disclosure. The wafer inspection system 20 may include a fixing lug 220 and a fixing lug 222, in which the fixing lug 220 and the fixing lug 222 include a fixing hole FH1 and a fixing hole FH2, respectively. Here, the assisting tool 30 and the fixing lug 220 will be used to determine the propagation path of the radiation beam R2 (see FIG. 1). The fixing lug 222 will be used to determine the propagation path of another radiation beam R4 (see FIG. 1), and will be discussed in more detail later.

During the determination of the propagation path of the radiation beam R2 (see FIG. 1), the assisting tool 30 is fixed on the fixing lug 220. Specifically, the fixing portion 300 of the assisting tool 30 is inserted into the fixing hole FH1 of the fixing lug 220. In some embodiments, the assisting tool 30 and the fixing lug 220 may be designed such that the dimension of the fixing portion 300 of the assisting tool 30 may fit the dimension of the fixing hole FH1 of the fixing lug 220. Accordingly, the assisting tool 30 can be stably fixed on the fixing lug 220.

The positions and the dimensions of the assisting tool 30 and the fixing lug 220 may be designed such that the assisting tool 30 is between the optical path between the turning mirror M1 and the scanner mirror M2 of the wafer inspection optical system 10. Specifically, the turning mirror M1 may direct the radiation beam R2 toward the scanner mirror M2, and the radiation beam R2 may pass through the hole H1 of the assisting tool 30. In some embodiments, the shape of the hole H1 of the assisting tool 30 may be designed to have substantially a same cross-sectional profile as the radiation beam R2. For example, it is observed that the radiation beam R2 includes a circular profile, and thus the hole H1 of the assisting tool 30 may be designed to have a circular profile.

The first end of the hole H1 at the flat surface of the assisting tool 30 may face upwardly toward the turning mirror M1, and the second end of the hole H1 at the curved surface of the assisting tool 30 may face downwardly toward the scanner mirror M2. Once the radiation beam R2 propagates toward the assisting tool 30, a portion of the radiation beam R2 may pass through the hole H1 of the assisting tool 30, while another portion of the radiation beam R2 may be incident onto the flat surface of the assisting tool 30 and create a light spot LS1 on the flat surface of the assisting tool 30. Based on the relationship between the light spot LS1 and the hole H1 of the assisting tool 30, the propagation path of the radiation beam R2 can be determined, which will be discussed in more detail later.

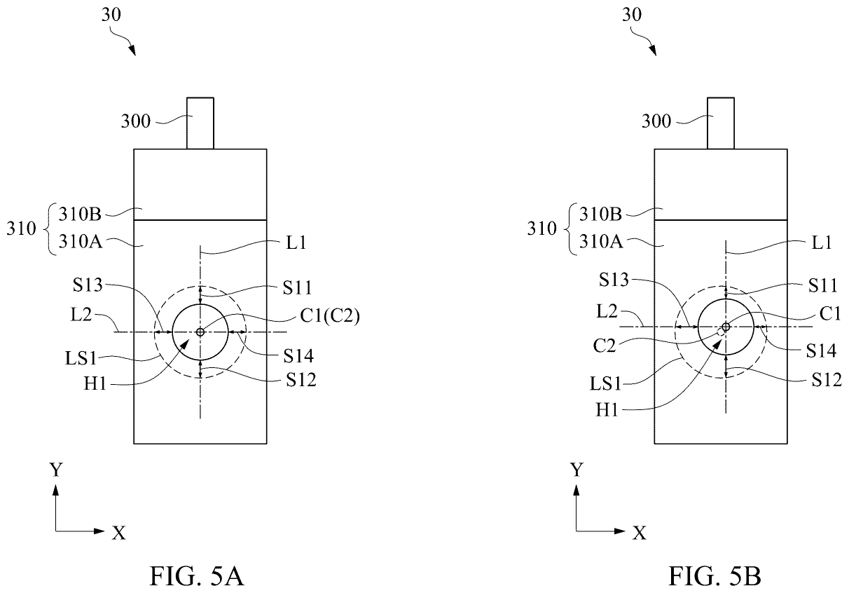

FIGS. 5A to 5B illustrate different conditions of determining a propagation path of a radiation beam in accordance with some embodiments of the present disclosure. In greater detail, FIG. 5A is a condition where the propagation path of the radiation beam R2 is along a predetermined propagation path, and FIG. 5B is a condition where the propagation path of the radiation beam R2 is offset from the predetermined propagation path.

A first example to determine the propagation path of the radiation beam R2 includes comparing the position of the center C1 of the hole H1 and the position of the center C2 of the light spot LS1. If the center C1 of the hole H1 overlaps with the center C2 of the light spot LS1, the propagation path of the radiation beam R2 is determined as along the predetermined propagation path. For example, in FIG. 5A, the center C1 of the hole H1 overlaps with the center C2 of the light spot LS1. However, if the center C1 of the hole H1 does not overlap with the center C2 of the light spot LS1, the propagation path of the radiation beam R2 is determined as offset from the predetermined propagation path. For example, in FIG. 5B, the center C1 of the hole H1 does not overlap with the center C2 of the light spot LS1.

A second example to determine the propagation path of the radiation beam R2 includes comparing the distance between the boundary of the hole H1 and the boundary of the light spot LS1. For example, in a first line L1 along the lengthwise direction of the assisting tool 30 and passing through the center C1 of the hole H1, a first end of the boundary of the hole H1 and the boundary of the light spot LS1 includes a shortest distance S11, and a second end of the boundary of the hole H1 and the boundary of the light spot LS1 includes a shortest distance S12, in which the first end is opposite to the second end. On the other hand, along a second line L2 perpendicular to the lengthwise direction of the assisting tool 30 and passing through the center C1 of the hole H1, a first end of the boundary of the hole H1 and the boundary of the light spot LS1 includes a shortest distance S13, and a second end of the boundary of the hole H1 and the boundary of the light spot LS1 includes a shortest distance S14.

If the distance S11 is substantially the same as the distance S12 and the distance S13 is substantially the same as the distance S14, the propagation path of the radiation beam R2 is determined as along the predetermined propagation path. For example, in FIG. 5A, the distance S11 is substantially the same as the distance S12 and the distance S13 is substantially the same as the distance S14. However, if the distance S11 is different from the distance S12 and/or the distance S13 is different from the distance S14, the propagation path of the radiation beam R2 is determined as offset from the predetermined propagation path. For example, in FIG. 5B, the distance S11 is different from the distance S12 and the distance S13 is different from the distance S14.

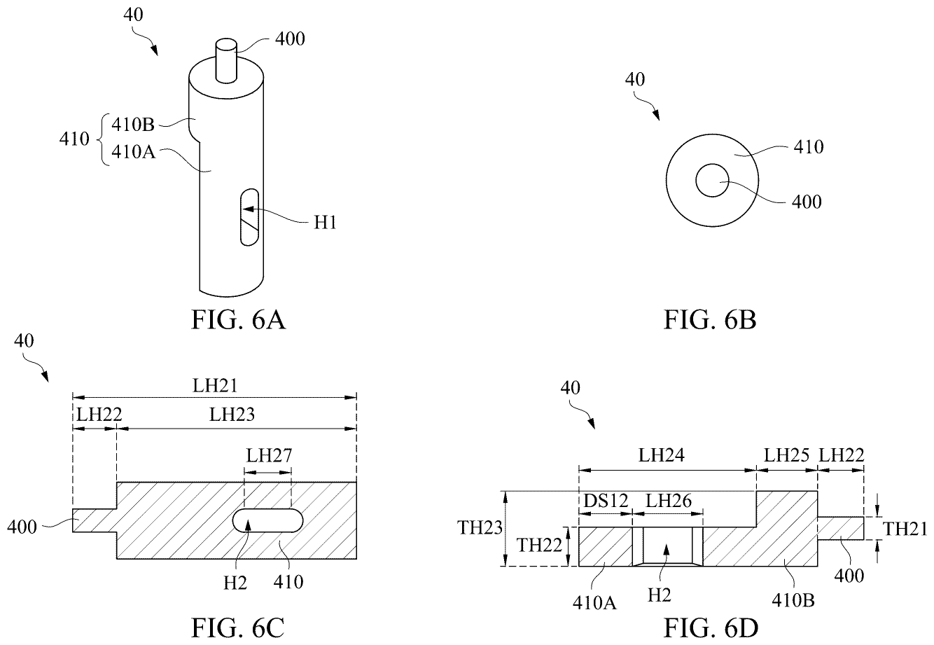

FIGS. 6A to 6D are various views of an assisting tool in accordance with some embodiments of the present disclosure. In greater detail, FIG. 6A is a schematic view of an assisting tool 40, FIG. 6B is a top view of the assisting tool 40, FIG. 6C is a side view of the assisting tool 40, and FIG. 6D is a cross-sectional view of the assisting tool 40. In some embodiments, the assisting tool 40 is used to check a propagation path of a radiation beam, and thus the assisting tool 40 can also be referred to as a beam checking tool.

The assisting tool 40 includes a fixing portion 400 and a body portion 410 connecting with each other. In greater detail, the body portion 410 further includes a first segment 410A and a second segment 410B connecting with each other. In some embodiments, the fixing portion 400 is in contact with the second segment 410B of the body portion 410. That is, the second segment 410B of the body portion 410 is between the fixing portion 400 and the first segment 410A of the body portion 410.

In some embodiments, the fixing portion 400 and the second segment 410B of the body portion 410 both include a cylindrical shape, while the first segment 410A of the body portion 410 includes a half-cylindrical shape. That is, the fixing portion 400 and the second segment 410B of the body portion 410 both include a circular cross-sectional profile, while the first segment 410A of the body portion 410 includes a substantially semicircular cross-sectional profile, while the disclosure is not limited thereto. In some embodiments, the first segment 410A of the body portion 410 includes a curved surface connecting with a flat surface. In some embodiments, the diameter of the circular cross-sectional profile of the fixing portion 400 is smaller than the diameter of the circular cross-sectional profile of the second segment 410B of the body portion 410.

In some embodiments, the body portion 410 may include a hole H2 penetrating through the first segment 410A of the body portion 410. Specifically, the hole H2 may extend from the flat surface of the first segment 410A of the body portion 410 to the curved surface of the first segment 410A of the body portion 410. Stated another way, a first end of the hole H2 may be at the flat surface of the first segment 410A of the body portion 410, and a second end of the hole H2 may be at the curved surface of the first segment 410A of the body portion 410. In some embodiments, the hole H2 may include a bar-shape profile with rounded opposite ends. Specifically, the shape of the hole H2 may include two linear sections connecting two curved sections.

As shown in FIG. 6C, along a longitudinal direction of the assisting tool 40, the assisting tool 40 includes a length LH21, the fixing portion 400 of the assisting tool 40 includes a length LH22, and the body portion of the assisting tool 40 includes a length LH23, in which the length LH21 is the sum of the length LH22 and the length LH23. In some embodiments, the length LH21 is about 59.8 mm to about 60.8 mm, such as 60.3 mm. The length LH22 is about 9.0 mm to about 10.0 mm, such as 9.5 mm. The length LH23 is about 50.3 mm to about 51.3 mm, such as 50.8 mm. The hole H2 may include a linear sidewall, the linear sidewall includes a length LH27. In some embodiments, the length LH27 is about 9.45 mm to about 10.45 mm, such as 9.95 mm.

As shown in FIG. 3D, the first segment 410A of the body portion 410 of the assisting tool 40 includes a length LH24 and the second segment 410B of the body portion 410 of the assisting tool 40 includes a length LH25, in which the length LH23 is the sum of the length LH24 and the length LH25. In some embodiments, the length LH24 is about 37.6.0 mm to about 38.6 mm, such as 38.1 mm. In some embodiments, the length LH25 is about 12.2 mm to about 13.2 mm, such as 12.7 mm. The hole H2 include a length LH26. In some embodiments, the length LH26 is about 14.45 mm to about 15.45 mm, such as 14.95 mm.

The edge of the hole H2 and an outer sidewall of the first segment 410A of the body portion 410 of the assisting tool 40 has a distance DS12 therebetween. In some embodiments, the distance DS12 is about 11.0 mm to about 12.0 mm, such as 11.5 mm. The fixing portion 400 of the assisting tool 40 includes a thickness TH21 (or diameter). In some embodiments, the thickness TH21 is about 4.2 mm to about 5.2 mm, such as 4.7 mm. The first segment 410A of the body portion 410 of the assisting tool 40 includes a thickness TH22, and the second segment 410B of the body portion 410 of the assisting tool 40 includes a thickness TH23 (or diameter). In some embodiments, the thickness TH22 is about 7.6 mm to about 8.6 mm, such as 8.1 mm. In some embodiments, the thickness TH23 is about 15.3 mm to about 16.3 mm, such as 15.8 mm.

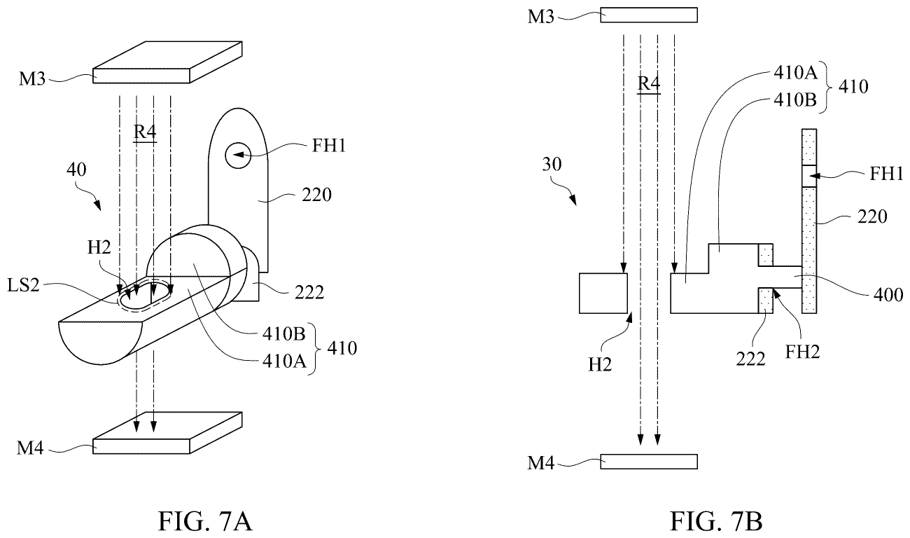

FIGS. 7A to 7B illustrate the relationship between an assisting tool and a fixing lug in accordance with some embodiments of the present disclosure. Here, the assisting tool 40 and the fixing lug 222 will be used to determine the propagation path of the radiation beam R4 (see FIG. 1).

During the determination of the propagation path of the radiation beam R4 (see FIG. 1), the assisting tool 40 is fixed on the fixing lug 222. Specifically, the fixing portion 400 of the assisting tool 40 is inserted into the fixing hole FH2 of the fixing lug 222. In some embodiments, the assisting tool 40 and the fixing lug 222 may be designed such that the dimension of the fixing portion 400 of the assisting tool 40 may fit the dimension of the fixing hole FH2 of the fixing lug 222. Accordingly, the assisting tool 40 can be stably fixed on the fixing lug 222. In some embodiments, the fixing hole FH2 of the fixing lug 222 is lower than the fixing hole FH1 of the fixing lug 220, and thus the assisting tool 40 is positioned at a level lower than the assisting tool 30 (see FIG. 4A).

The positions and the dimensions of the assisting tool 40 and the fixing lug 222 may be designed such that the assisting tool 40 is between the optical path between the telecentric scan mirror M3 and the incident mirror M4 of the wafer inspection optical system 10. Specifically, the telecentric scan mirror M3 may direct the radiation beam R4 toward the incident mirror M4, and the radiation beam R4 may pass through the hole H2 of the assisting tool 40. In some embodiments, the shape of the hole H2 of the assisting tool 40 may be designed to have a similar or substantially a same cross-sectional profile as the radiation beam R4. In some embodiments, the hole H2 and the radiation beam R4 may include a bar-shape profile with rounded opposite ends. In other embodiments, the radiation beam R4 may include an elliptical profile.

The first end of the hole H2 at the flat surface of the assisting tool 40 may face upwardly toward the telecentric scan mirror M3, and the second end of the hole H2 at the curved surface of the assisting tool 40 may face downwardly toward the incident mirror M4. Once the radiation beam R4 propagates toward the assisting tool 40, a portion of the radiation beam R4 may pass through the hole H2 of the assisting tool 40, while another portion of the radiation beam R4 may be incident onto the flat surface of the assisting tool 40 and create a light spot LS2 on the flat surface of the assisting tool 40. Based on the relationship between the light spot LS2 and the hole H2 of the assisting tool 40, the propagation path of the radiation beam R4 can be determined, which will be discussed in more detail later.

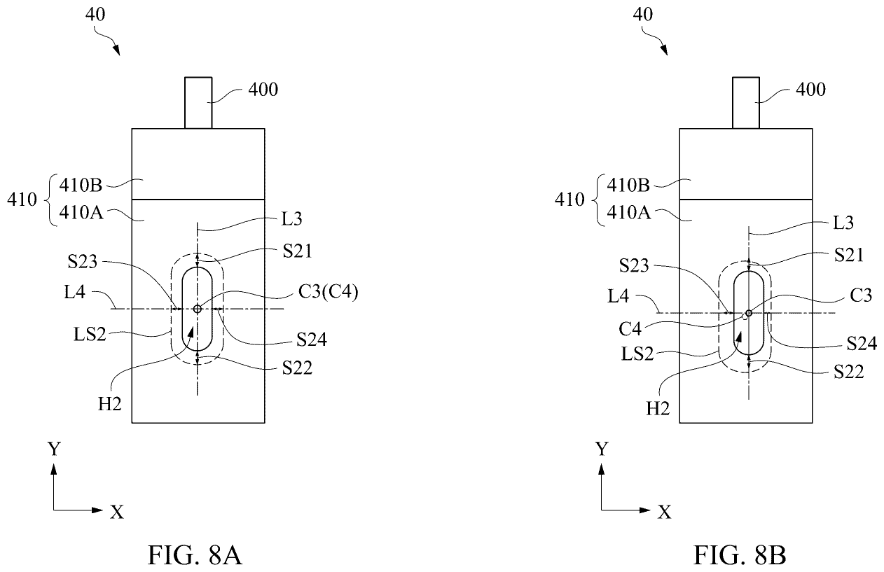

FIGS. 8A to 8B illustrate different conditions of determining a propagation path of a radiation beam in accordance with some embodiments of the present disclosure. In greater detail, FIG. 8A is a condition where the propagation path of the radiation beam R4 is along a predetermined propagation path, and FIG. 8B is a condition where the propagation path of the radiation beam R4 is offset from the predetermined propagation path.

A first example to determine the propagation path of the radiation beam R4 includes comparing the position of the center C3 of the hole H2 and the position of the center C4 of the light spot LS2. If the center C3 of the hole H2 overlaps with the center C4 of the light spot LS2, the propagation path of the radiation beam R4 is determined as along the predetermined propagation path. For example, in FIG. 8A, the center C3 of the hole H2 overlaps with the center C4 of the light spot LS2. However, if the center C3 of the hole H2 does not overlap with the center C4 of the light spot LS2, the propagation path of the radiation beam R4 is determined as offset from the predetermined propagation path. For example, in FIG. 8B, the center C3 of the hole H2 does not overlap with the center C4 of the light spot LS2.

A second example to determine the propagation path of the radiation beam R4 includes comparing the distance between the boundary of the hole H2 and the boundary of the light spot LS2. For example, in a first line L3 along the lengthwise direction of the assisting tool 40 and passing through the center C3 of the hole H2, a first end of the boundary of the hole H2 and the boundary of the light spot LS2 includes a shortest distance S21, and a second end of the boundary of the hole H2 and the boundary of the light spot LS2 includes a shortest distance S22, in which the first end is opposite to the second end. On the other hand, along a second line L4 perpendicular to the lengthwise direction of the assisting tool 40 and passing through the center C3 of the hole H2, a first end of the boundary of the hole H2 and the boundary of the light spot LS2 includes a shortest distance S23, and a second end of the boundary of the hole H2 and the boundary of the light spot LS2 includes a shortest distance S24.

If the distance S21 is substantially the same as the distance S22 and the distance S23 is substantially the same as the distance S24, the propagation path of the radiation beam R4 is determined as along the predetermined propagation path. For example, in FIG. 8A, the distance S21 is substantially the same as the distance S22 and the distance S23 is substantially the same as the distance S24. However, if the distance S21 is different from the distance S22 and/or the distance S23 is different from the distance S24, the propagation path of the radiation beam R4 is determined as offset from the predetermined propagation path. For example, in FIG. 8B, the distance S21 is different from the distance S22 and the distance S23 is different from the distance S24.

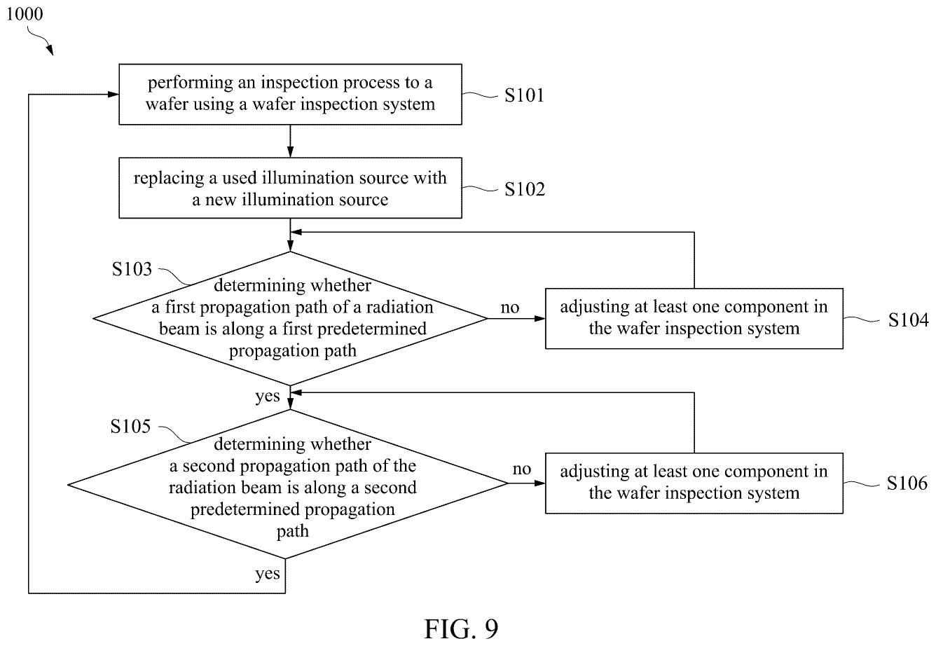

FIG. 9 is a method of replacing an illumination source of a wafer inspection system in accordance with some embodiments. A method 1000 is provided, and the method 1000 of FIG. 9 will be discussed in conjunction with FIGS. 1 to 8B as discussed above. Although the method 1000 is described as a series of acts, it will be appreciated that these acts are not limiting in that the order of the acts can be altered in other embodiments. In other embodiments, some acts that are illustrated and/or described may be omitted in whole or in part.

The method 1000 starts from operation S101 by performing an inspection process to a wafer using a wafer inspection system. In greater detail, a wafer W may be loaded into the wafer load port 210 of the wafer inspection tool 200 of the wafer inspection system 20, and will be placed on a wafer stage (not shown). Then, an inspection process is performed to the wafer W using the wafer inspection optical system 10 as discussed in FIG. 1. For example, as shown in FIG. 1, the illumination source 100 may generate a radiation beam, and the radiation beam is directed to a surface of the wafer W. The radiation beam illuminates a defect on the surface of the wafer W, the radiation light is scattered away from the point of incidence. The scattered light is then collected by the photomultiplier tube 130, which is configured to amplify the optical signal and generates a corresponding electrical output. The output of the photomultiplier tube 130 is digitized by an analog-to-digital converter (not shown). Then the particle position (e.g., defect position) on the wafer W can be determined based upon the collected radiation.

The method 1000 proceeds to operation S102 by replacing a used illumination source with a new illumination source. As mentioned above, the average lifetime of the illumination source (e.g., the illumination source 100 in FIG. 1) is about 10 month to about 12 month. That is, after several inspection processes, the performance of the used illumination source may not be satisfying. For example, the intensity of the radiation beam may not be enough, and may affect the inspection quality. Accordingly, the used illumination source will be replaced with a new illumination source. For example, the used illumination source 100 may be removed from the wafer inspection tool 200 (see FIG. 2), and then a new illumination source 100 is installed in the wafer inspection tool 200.

The method 1000 proceeds to operation S103 by determining whether a first propagation path of a radiation beam is along a first predetermined propagation path. In some embodiments, once the new illumination source 100 is installed in the wafer inspection tool 200, the new illumination source 100 may not be at a right position, and thus the radiation beam generated from the new illumination source 100 may not aim at a correct orientation.

In some embodiments, determining whether a first propagation path of a radiation beam is along a first predetermined propagation path includes using the assisting tool 30 (see FIGS. 3A to 3D) to determine the propagation path of the radiation beam R2. For example, the assisting tool 30 is fixed on the fixing lug 220 in the wafer inspection tool 200 (see FIGS. 4A and 4B). Then, the new illumination source 100 is operated to generate a radiation beam, and the assisting tool 30 is used to determine the propagation path of the radiation beam R2. Details of determining the propagation path of the radiation beam R2 has been discussed above with respect to FIGS. 5A and 5B, and will not be repeated for brevity.

If the propagation path of the radiation beam R2 is not along the predetermined propagation path, the method proceeds to operation S104 by adjusting at least one component in the wafer inspection system. For example, the position of the new illumination source 100 can be modified, so as to change the propagation path of the radiation beam generated from the new illumination source 100. Such modification can adjust the propagation path of the radiation beam R2. Then, the method return to the operation S103. In some embodiments, during the modification of the position of the new illumination source 100, the assisting tool 30 can be placed on the fixing lug 220 to see how the propagation path of the radiation beam R2 changes. This will be beneficial to obtain a correct propagation path of the radiation beam R2.

If the propagation path of the radiation beam R2 is along the predetermined propagation path, the method proceeds to operation S105 by determining whether a second propagation path of the radiation beam is along a second predetermined propagation path. In some embodiments, determining whether a second propagation path of the radiation beam is along a second predetermined propagation path includes using the assisting tool 40 (see FIGS. 6A to 6D) to determine the propagation path of the radiation beam R4. For example, the assisting tool 40 is fixed on the fixing lug 222 in the wafer inspection tool 200 (see FIGS. 7A and 7B). Then, the new illumination source 100 is operated to generate a radiation beam, and the assisting tool 40 is used to determine the propagation path of the radiation beam R4. Details of determining the propagation path of the radiation beam R4 has been discussed above with respect to FIGS. 8A and 8B, and will not be repeated for brevity.

If the propagation path of the radiation beam R4 is not along the predetermined propagation path, the method proceeds to operation S106 by adjusting at least one component in the wafer inspection system. For example, the position of the scanner mirror M2 can be modified, so as to change the propagation path of the radiation beam R3 (see FIG. 1). Such modification can also adjust the propagation path of the radiation beam R4. Then, the method 1000 may return to the operation S105. In some embodiments, during the modification of the position of the scanner mirror M2, the assisting tool 40 can be placed on the fixing lug 222 to see how the propagation path of the radiation beam R4 changes. This will be beneficial to obtain a correct propagation path of the radiation beam R4.

If the propagation path of the radiation beam R4 is along the predetermined propagation path, the method returns to operation S101. In greater detail, an inspection process is performed to a wafer W using the new illumination source 100. It is understood that prior to performing the operation S101 again, the assisting tool 30 and the assisting tool 40 may be removed from the wafer inspection tool 200.

It is understood that during the operations S103 and S104, the assisting tool 30 is fixed on the fixing lug 220, while the assisting tool 40 used in operations S105 and S106 may not be fixed on the fixing lug 222. If the assisting tool 40 is fixed on the fixing lug 222 during the operations S103 and S104, the assisting tool 40 may block the propagation path of the radiation beam. Accordingly, the assisting tool 40 (if present) will be removed from the fixing lug 222 prior to performing the operations S103 and S104. Similarly, during the operations S105 and S106, the assisting tool 40 is fixed on the fixing lug 222, while the assisting tool 30 used in operations S103 and S104 may not be fixed on the fixing lug 220. If the assisting tool 30 is fixed on the fixing lug 220 during the operations S105 and S106, the assisting tool 30 may block the propagation path of the radiation beam. Accordingly, the assisting tool 30 (if present) will be removed from the fixing lug 220 prior to performing the operations S105 and S106.

In other embodiments, if the assisting tool 30 does not affect the propagation path of the radiation beam during the operations S105 and S106, and the assisting tool 40 does not affect the propagation path of the radiation beam during the operations S103 and S104, the assisting tools 30 and 40 can both be fixed on the fixing lugs 220 and 222, respectively, during the operations S103, S104, S105, and S106.

In some embodiments, the assisting tools 30 and 40 are detachable from the fixing lugs 220 and 222, respectively. Accordingly, during performing the inspection process (e.g., operation S101), the assisting tools 30 and 40 may be removed from the fixing lugs 220 and 222, respectively. However, in other embodiments, the assisting tools 30 and 40 may be fixed on the fixing lugs 220 and 222, respectively, during performing the inspection process (e.g., operation S101). This is because the radiation beam can still path through the holes H1 and H2 of the assisting tools 30 and 40 if the propagation path is correct.

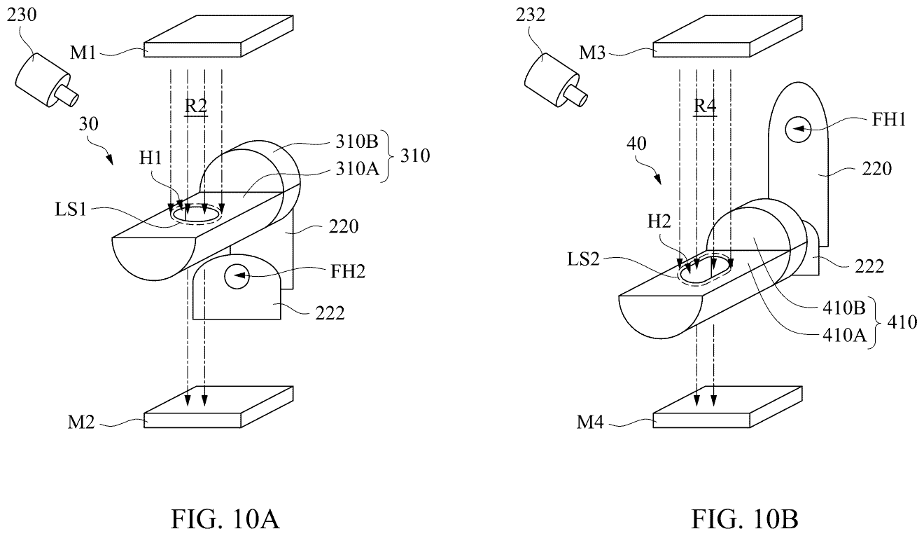

FIGS. 10A and 10B illustrate the relationship between an assisting tool and a fixing lug in accordance with some embodiments of the present disclosure. FIGS. 10A and 10B are similar to FIGS. 4A and 7A, respectively. Some elements of FIGS. 10A and 10B have been discussed in FIGS. 4A and 7A, and thus relevant details will not be repeated for brevity.

In FIG. 10A, shown there is an image capturing device 230 disposed in the wafer inspection tool 200 of the wafer inspection system 20. In some embodiments, the image capturing device 230 is a camera, image sensor, or other suitable image capturing device. In some embodiments, the image capturing device 230 is configured to capture an image of the flat surface of the assisting tool 30. Specifically, the image capturing device 230 is able to capture an image that includes the hole H1 of the assisting tool 30 and the light spot LS1 on the flat surface of the assisting tool 30 during the operation S103 as discussed in FIG. 9. In some embodiments, the captured image can be sent to a computer system (e.g., the computer system 240 in FIG. 11), and the computer system may automatically calculate the positions (or shapes) of the hole H1 and the light spot LS1, and may determine whether the propagation path of the radiation beam R2 is along the predetermined propagation path.

Similarly, in FIG. 10B, shown there is an image capturing device 232 disposed in the wafer inspection tool 200 of the wafer inspection system 20. In some embodiments, the image capturing device 232 is a camera, image sensor, or other suitable image capturing device. In some embodiments, the image capturing device 232 is configured to capture an image of the flat surface of the assisting tool 40. Specifically, the image capturing device 232 is able to capture an image that includes the hole H2 of the assisting tool 40 and the light spot LS2 on the flat surface of the assisting tool 40 during the operation S105 as discussed in FIG. 9. In some embodiments, the captured image can be sent to a computer system (not shown), and the computer system may automatically calculate the positions (or shapes) of the hole H2 and the light spot LS2, and may determine whether the propagation path of the radiation beam R4 is along the predetermined propagation path.

FIG. 11 is block diagram of a wafer inspection system in accordance with some embodiments of the present disclosure. The wafer inspection system 20 includes a wafer inspection tool 200. The wafer inspection system 20 also includes a wafer inspection optical system 10, an input device 202, an output device 204, image capturing devices 230 and 232, and a computer system 240. In some embodiments, the computer system 240 may be electrically communicated with the wafer inspection optical system 10, the input device 202, the output device 204, and the image capturing devices 230 and 232.

In some embodiments, the computer system 240 may a controller and a computer readable storage medium encoded with, i.e., storing, a computer program code, i.e., a set of executable instructions. The controller is electrically coupled to the computer readable storage medium. The controller is configured to execute the computer program code encoded in the computer readable storage medium in order to cause the computer system 240 to be used to performing the operations as discussed above with respect to FIG. 9.

In some embodiments, the controller is a central processing unit (CPU), a multi-processor, a distributed processing system, an application specific integrated circuit (ASIC), and/or a suitable processing unit. In some embodiments, the computer readable storage medium includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium includes a compact disk-read only memory (CD-ROM), a compact disk-read/write (CD-R/W), and/or a digital video disc (DVD).

According to the aforementioned embodiments, it can be seen that the present disclosure offers advantages in fabricating integrated circuits. It is understood, however, that other embodiments may offer additional advantages, and not all advantages are necessarily disclosed herein, and that no particular advantage is required for all embodiments. Embodiments of the present disclosure provide a wafer inspection system and a method thereof by using at least one beam checking tool to determine whether a radiation beam propagates along a predetermined propagation path, and the propagation path of the radiation beam can be adjusted when it is offset from the predetermined propagation path. With such configuration, the inspection performance can be improved.

In some embodiments of the present disclosure, a method includes performing a first wafer inspection process using an illumination source in a wafer inspection tool; replacing the illumination source with a new illumination source; generating a radiation beam from the new illumination source; placing an assisting tool along a propagation path of the radiation beam, wherein the assisting tool has a hole, and wherein the radiation beam creates a light spot around the hole of the assisting tool; determining whether the propagation path of the radiation beam is along a predetermined propagation path based on a position of the hole and a position of the light spot; and performing a second wafer inspection process using the new illumination source in response to the propagation path of the radiation beam being determined as along the predetermined propagation path.

In some embodiments, the assisting tool includes a fixing portion and a body portion connecting with the fixing portion and having a flat surface, in which the light spot is created on the flat surface of the body portion.

In some embodiments, placing the assisting tool along the propagation path of the radiation beam includes fixing the assisting tool on a fixing lug in the wafer inspection tool by inserting the fixing portion of the assisting tool into a fixing hole of the fixing lug.

In some embodiments, the flat surface faces upwardly during determining whether the propagation path of the radiation beam is along the predetermined propagation path.

In some embodiments, the method further includes adjusting a position of the illumination source in response to the propagation path of the radiation beam being determined as offset from the predetermined propagation path.

In some embodiments, determining whether the propagation path of the radiation beam is along the predetermined propagation path includes comparing a first shortest distance between a first end of the hole to a boundary of the light spot along a line passing through a center of the hole and a second shortest distance between a second end of the hole to the boundary of the light spot along the line passing through the center of the hole, and wherein the propagation path of the radiation beam is determined as along the predetermined propagation path when the first shortest distance is substantially the same as the second shortest distance.

In some embodiments, determining whether the propagation path of the radiation beam is along the predetermined propagation path comprises comparing a position of a center of the hole of the assisting tool with a position of a center of the light spot, and wherein the propagation path of the radiation beam is determined as along the predetermined propagation path when the center of the hole of the assisting tool overlaps with the center of the light spot.

In some embodiments, the method further includes removing the assisting tool from the wafer inspection tool prior to performing the second wafer inspection process.

In some embodiments of the present disclosure, a method includes generating a radiation beam from an illumination source in a wafer inspection tool; placing a first assisting tool along a first propagation path of the radiation beam, wherein the first assisting tool has a first hole, and wherein the radiation beam creates a first light spot around the first hole of the first assisting tool; determining whether the first propagation path of the radiation beam is along a first predetermined propagation path based on a position of the first hole and a position of the first light spot; placing a second assisting tool along a second propagation path of the radiation beam in response to the first propagation path of the radiation beam being determined as along the first predetermined propagation path, wherein the second assisting tool has a second hole, and wherein the radiation beam creates a second light spot around the second hole of the second assisting tool; determining whether the second propagation path of the radiation beam is along a second predetermined propagation path based on a position of the second hole and a position of the second light spot; and performing a wafer inspection process using the illumination source in response to the second propagation path of the radiation beam being determined as along the second predetermined propagation path.

In some embodiments, the first hole and the second hole have different shapes.

In some embodiments, the first hole has a circular shape and the second hole has bar-shape with rounded opposite ends.

In some embodiments, the second assisting tool is at a level lower than the first assisting tool.

In some embodiments, the method further includes removing the first assisting tool prior to placing the second assisting tool along the second propagation path of the radiation beam.

In some embodiments, the method further includes adjusting a position of the illumination source in response to the first propagation path of the radiation beam being determined as offset from the first predetermined propagation path.

In some embodiments, the first assisting tools and the second assisting tool each includes a fixing portion and a body portion connecting with the fixing portion, the body portion including a first segment and a second segment, and the second segment of the body portion being connecting with the fixing portion, in which the fixing portion and the second segment of the body portion includes a cylindrical shape, and the first segment of the body portion includes a half-cylindrical shape.

In some embodiments of the present disclosure, a wafer inspection system includes a wafer inspection tool. An illumination source is in the wafer inspection tool and configured to generate a radiation beam. A first optical element and a second optical element are in the wafer inspection tool and optically communicated with the illumination source, in which the first optical element directs the radiation beam toward the second optical element. A first beam checking tool is between the first optical element and the second optical element, wherein the first beam checking tool comprises a first hole, and the radiation beam propagates through the first hole of the first beam checking tool.

In some embodiments, the wafer inspection system further includes a first fixing lug in the wafer inspection tool, in which the first beam checking tool is fixed on the first fixing lug is detachable from the first fixing lug.

In some embodiments, the first beam checking tool includes a flat surface facing upwardly, and the first hole is at the flat surface of the first beam checking tool.

In some embodiments, the wafer inspection system further includes a third optical element and a fourth optical element in the wafer inspection tool and optically communicated with the illumination source, in which the second optical element directs the radiation beam toward third optical element, and the third optical element directs the radiation beam toward the fourth optical element. A second beam checking tool is between the third optical element and the fourth optical element, in which the second beam checking tool includes a second hole, and the radiation beam propagates through the second hole of the second beam checking tool.

In some embodiments, the first hole of the first beam checking tool and the second hole of the second beam checking tool have different shapes.

In some embodiments, the first hole has a circular shape and the second hole has a bar-shape with rounded opposite ends.

In some embodiments of the present disclosure, a wafer inspection system includes a wafer inspection tool. An illumination source is in the wafer inspection tool and configured to generate a radiation beam. A first optical element and a second optical element are in the wafer inspection tool and are optically communicated with the illumination source, wherein the first optical element directs the radiation beam toward the second optical element. A first fixing lug is in the wafer inspection tool. A first beam checking tool is fixed on the first fixing lug, wherein the radiation beam propagates through the first beam checking tool.

In some embodiments, the first beam checking tool comprises a fixing portion inserted in a fixing hole of the first fixing lug, and a body portion coupled to the fixing portion and having a hole, wherein the radiation beam propagates through the hole of first beam checking tool.

In some embodiments, the body portion has a flat surface facing upwardly.

In some embodiments, the radiation beam creates a light spot on the flat surface of the body portion.

In some embodiments, the first beam checking tool is detachable from the first fixing lug.

In some embodiments, the wafer inspection system further includes a third optical element and a fourth optical element in the wafer inspection tool and optically communicated with the illumination source, wherein the second optical element directs the radiation beam toward third optical element, and the third optical element directs the radiation beam toward the fourth optical element. A second fixing lug is in the wafer inspection tool. A second beam checking tool is fixed on the second fixing lug, wherein the radiation beam propagates through the first beam checking tool, and wherein the first beam checking tool has a first hole and the second beam checking tool has a second hole, and the first hole and the second hole have different shapes.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
performing a first wafer inspection process using an illumination source in a wafer inspection tool;
replacing the illumination source with a new illumination source;
generating a radiation beam from the new illumination source;
placing an assisting tool along a propagation path of the radiation beam, wherein the assisting tool has a hole, and wherein the radiation beam creates a light spot around the hole of the assisting tool;
determining whether the propagation path of the radiation beam is along a predetermined propagation path based on a position of the hole and a position of the light spot; and
performing a second wafer inspection process using the new illumination source in response to the propagation path of the radiation beam being determined as along the predetermined propagation path.

2. The method of claim 1, wherein the assisting tool comprises:
a fixing portion; and
a body portion connecting with the fixing portion and having a flat surface, wherein the light spot is created on the flat surface of the body portion.

3. The method of claim 2, wherein placing the assisting tool along the propagation path of the radiation beam comprises fixing the assisting tool on a fixing lug in the wafer inspection tool by inserting the fixing portion of the assisting tool into a fixing hole of the fixing lug.

4. The method of claim 2, wherein the flat surface faces upwardly during determining whether the propagation path of the radiation beam is along the predetermined propagation path.

5. The method of claim 1, further comprising adjusting a position of the illumination source in response to the propagation path of the radiation beam being determined as offset from the predetermined propagation path.

6. The method of claim 1, wherein determining whether the propagation path of the radiation beam is along the predetermined propagation path comprises:
comparing a first shortest distance between a first end of the hole to a boundary of the light spot along a line passing through a center of the hole and a second shortest distance between a second end of the hole to the boundary of the light spot along the line passing through the center of the hole, and wherein the propagation path of the radiation beam is determined as along the predetermined propagation path when the first shortest distance is substantially the same as the second shortest distance.

7. The method of claim 1, wherein determining whether the propagation path of the radiation beam is along the predetermined propagation path comprises comparing a position of a center of the hole of the assisting tool with a position of a center of the light spot, and wherein the propagation path of the radiation beam is determined as along the predetermined propagation path when the center of the hole of the assisting tool overlaps with the center of the light spot.

8. The method of claim 1, further comprising removing the assisting tool from the wafer inspection tool prior to performing the second wafer inspection process.

9. A wafer inspection system, comprising:
a wafer inspection tool;
an illumination source in the wafer inspection tool and configured to generate a radiation beam;
a first optical element and a second optical element in the wafer inspection tool and optically communicated with the illumination source, wherein the first optical element directs the radiation beam toward the second optical element; and
a first beam checking tool between the first optical element and the second optical element, wherein the first beam checking tool comprises a first hole, and the radiation beam propagates through the first hole of the first beam checking tool.

10. The wafer inspection system of claim 9, further comprising a first fixing lug in the wafer inspection tool, wherein the first beam checking tool is fixed on the first fixing lug and is detachable from the first fixing lug.

11. The wafer inspection system of claim 9, wherein the first beam checking tool comprises a flat surface facing upwardly, and the first hole is at the flat surface of the first beam checking tool.

12. The wafer inspection system of claim 9, further comprising:
a third optical element and a fourth optical element in the wafer inspection tool and optically communicated with the illumination source, wherein the second optical element directs the radiation beam toward third optical element, and the third optical element directs the radiation beam toward the fourth optical element; and
a second beam checking tool between the third optical element and the fourth optical element, wherein the second beam checking tool comprises a second hole, and the radiation beam propagates through the second hole of the second beam checking tool.

13. The wafer inspection system of claim 12, wherein the first hole of the first beam checking tool and the second hole of the second beam checking tool have different shapes.

14. The wafer inspection system of claim 13, wherein the first hole has a circular shape and the second hole has a bar-shape with rounded opposite ends.

15. A wafer inspection system, comprising:
a wafer inspection tool;
an illumination source in the wafer inspection tool and configured to generate a radiation beam;
a first optical element and a second optical element in the wafer inspection tool and optically communicated with the illumination source, wherein the first optical element directs the radiation beam toward the second optical element;
a first fixing lug in the wafer inspection tool; and
a first beam checking tool fixed on the first fixing lug, wherein the radiation beam propagates through the first beam checking tool.

16. The wafer inspection system of claim 15, wherein the first beam checking tool comprises:
a fixing portion inserted in a fixing hole of the first fixing lug; and
a body portion coupled to the fixing portion and having a hole, wherein the radiation beam propagates through the hole of the body portion.

17. The wafer inspection system of claim 16, wherein the body portion has a flat surface facing upwardly.

18. The wafer inspection system of claim 17, wherein the radiation beam creates a light spot on the flat surface of the body portion.

19. The wafer inspection system of claim 15, wherein the first beam checking tool is detachable from the first fixing lug.

20. The wafer inspection system of claim 15, further comprising:
a third optical element and a fourth optical element in the wafer inspection tool and optically communicated with the illumination source, wherein the second optical element directs the radiation beam toward third optical element, and the third optical element directs the radiation beam toward the fourth optical element;
a second fixing lug in the wafer inspection tool; and
a second beam checking tool fixed on the second fixing lug, wherein the radiation beam propagates through the first beam checking tool, and wherein the first beam checking tool has a first hole and the second beam checking tool has a second hole, and the first hole and the second hole have different shapes.
